(19) United States
(12) Patent Application Publication
(10) Pub. No.: US 2018/0200795 A1
(43) Pub. Date: Jul. 19, 2018

(54) METHOD FOR MANUFACTURING THREE-DIMENSIONAL SHAPED OBJECT AND THREE-DIMENSIONAL SHAPED OBJECT

(71) Applicant: PANASONIC INTELLECTUAL PROPERTY MANAGEMENT CO., LTD., Osaka (JP)

(72) Inventors: Masanori MORIMOTO, Osaka (JP); Satoshi ABE, Osaka (JP); Akifumi NAKAMURA, Osaka (JP); Isao FUWA, Osaka (JP)

(73) Assignee: PANASONIC INTELLECTUAL PROPERTY MANAGEMENT CO., LTD., Osaka (JP)

(21) Appl. No.: 15/748,427

(22) PCT Filed: Feb. 8, 2016
(86) PCT No.: PCT/JP2016/000645

§ 371 Date: Jan. 29, 2018

(30) Foreign Application Priority Data
Jul. 31, 2015 (JP) 2015-152057

(51) Int. Cl. B22F 3/105; B22F 3/16; B22F 5/00; B29C 33/38; B29C 64/153; B29C 64/188

(52) U.S. Cl. CPC B22F 3/1055; B22F 3/162; B22F 5/007; B29C 67/0011; B29C 64/153; B29C 64/188; B29C 33/3842

(57) ABSTRACT

In order to to provide a manufacturing method of a three-dimensional shaped object having a more proper heat removal property to be used as a metal mold, there is provided that a method for manufacturing a three-dimensional shaped object by alternate repetition of a powder-layer forming and a solidified-layer forming, the repetition comprising: (i) forming a solidified layer by irradiating a predetermined portion of a powder layer with a light beam, thereby allowing a sintering of the powder in the predetermined portion or a melting and subsequent solidification of the powder; and (ii) forming another solidified layer by forming a new powder layer on the formed solidified layer, followed by irradiation of a predetermined portion of the newly formed powder layer with the light beam, wherein the manufacturing method of the present invention, the three-dimensional shaped object is manufactured such that it has a flow path for cooling media in the three-dimensional shaped object, and also has a surface in a form of a concavity-convexity, and wherein a part of a contour surface of the flow path for the cooling media and the surface of the concavity-convexity have the same shape as each other.

### CROSS REFERENCE TO RELATED PATENT APPLICATION

The present application claims the right of priority of Japanese Patent Application No. 2015-152057 (filed on Jul. 31, 2015, the title of the invention: “METHOD FOR MANUFACTURING THREE-DIMENSIONAL SHAPED OBJECT AND THREE-DIMENSIONAL SHAPED OBJECT”), the disclosure of which is incorporated herein by reference.

### TECHNICAL FIELD

The disclosure relates to a method for manufacturing a three-dimensional shaped object and a three-dimensional shaped object. More particularly, the disclosure relates to a method for manufacturing a three-dimensional shaped object, in which a formation of a solidified layer is performed by an irradiation of a powder layer with a light beam, and a three-dimensional shaped object to be obtained by the method.

### BACKGROUND OF THE INVENTION

Heretofore, a method for manufacturing a three-dimensional shaped object by irradiating a powder material with a light beam has been known (such method can be generally referred to as “selective laser sintering method”). The method can produce the three-dimensional shaped object by an alternate repetition of a powder-layer forming and a solidified-layer forming on the basis of the following (i) and (ii):

(i) forming a solidified layer by irradiating a predetermined portion of a powder layer with a light beam, thereby allowing a sintering of the predetermined portion of the powder or a melting and subsequent solidification of the predetermined portion; and

(ii) forming another solidified layer by forming a new powder layer on the formed solidified layer, followed by similarly irradiating the powder layer with the light beam.

This kind of the manufacturing technology makes it possible to produce the three-dimensional shaped object with its complicated contour shape in a short period of time. The three-dimensional shaped object can be used as a metal mold in a case where inorganic powder material (e.g., metal powder material) is used as the powder material. While on the other hand, the three-dimensional shaped object can also be used as various kinds of models or replicas in a case where organic powder material (e.g., resin powder material) is used as the powder material.

Taking a case as an example wherein the metal powder is used as the powder material, and the three-dimensional shaped object produced therefrom is used as the metal mold, the selective laser sintering method will now be briefly described. A powder is firstly transferred onto a base plate 21 by a movement of a squeegee blade 23, and thereby a powder layer 22 with its predetermined thickness is formed on the base plate 21 (see FIG. 6A). Then, a predetermined portion of the powder layer is irradiated with a light beam “L” to form a solidified layer 24 (see FIG. 6B). Another powder layer is newly provided on the solidified layer thus formed, and is irradiated again with the light beam to form another solidified layer. In this way, the powder-layer forming and the solidified-layer forming are alternately repeated, and thereby allowing the solidified layers 24 to be stacked with each other (see FIG. 6C). The alternate repetition of the powder-layer forming and the solidified-layer forming leads to a production of a three-dimensional shaped object with a plurality of the solidified layers integrally stacked therein. The lowermost solidified layer 24 can be provided in a state of adhering to the surface of the base plate 21. Therefore, there can be obtained an integration of the three-dimensional shaped object and the base plate. The integrated “three-dimensional shaped object” and “base plate” can be used as the metal mold as they are.

### PATENT DOCUMENTS (RELATED ART PATENT DOCUMENTS)

PATENT DOCUMENT 1: Japanese Unexamined Patent Application Publication No. H01-502890

PATENT DOCUMENT 2: Japanese Unexamined Patent Application Publication No. 2000-73108

### DISCLOSURE OF THE INVENTION

### Problems to be Solved by the Invention

When the three-dimensional shaped object is used as the metal mold, a mold cavity is filled with a raw material for a molding in a melt state to finally obtain a molded article, the mold cavity being formed by a combination of so called “core side” mold and “cavity side” moLd. Specifically, the mold cavity is filled with the raw material for the molding in the melt state, and subsequently the raw material for the molding is cooled in the mold cavity to solidify the raw material for the molding, which finally leads to a manufacturing of a molded article. More specifically, a removal of heat arising from the raw material for the molding filled in the mold cavity is performed in a process of a state change from the melt state to a solidifided state, which leads to the manufacturing of the molded article from the raw material for the molding.

The removal of the heat from arising the raw material for the molding may result from a transfer of a heat arising from the raw material for the molding filled in the mold cavity with respect to the metal mold. In order to promote the removal of the heat, there is a case where the three-dimensional shaped object has a flow path for cooling media therein.

Inventors of the present application have found that the flow path for the cooling media having a predetermined configuration may make a desired removal of the heat arising from the raw material for the molding difficult. The flow path for the cooling media to be generally used has a relatively simple cross-sectional contour shape which includes a simple shape such as a rectangular shape and a circular shape. The flow path for the coolig media having such the simple shape may result in an ununiform removal of the heat arising from the raw material for the molding in the mold cavity, which may lead to an occurrence of a molding defect. For example, The ununiform removal of the heat may cause problems such as a reduction of a shape accuracy of the molded article.

Under these circumstances, the present invention has been created. That is, an object of the present invention is to provide a manufacturing method of the three-dimensional shaped object having a more proper heat removal property to be used as a metal mold and the three-dimensional shaped object itself having a more proper heat removal property.

### Means for Solving the Problems

In order to achieve the above object, an embodiment of the present invention provides a method for manufacturing a three-dimensional shaped object by alternate repetition of a powder-layer forming and a solidified-layer forming, the repetition comprising:

(i) forming a solidified layer by irradiating a predetermined portion of a powder layer with a light beam, thereby allowing a sintering of the powder in the predetermined portion or a melting and subsequent solidification of the powder; and

(ii) forming another solidified layer by forming a new powder layer on the formed solidified layer, followed by irradiation of a predetermined portion of the newly formed powder layer with the light beam,

wherein the three-dimensional shaped object is manufactured such that it has a flow path for cooling media in the three-dimensional shaped object, and also has a surface in a form of a concavity-convexity, and

wherein a part of a contour surface of the flow path for the cooling media and the surface of the concavity-convexity have the same shape as each other.

In order to achieve the above object, an embodiment of the present invention provides a three-dimensional shaped object comprising a flow path for cooling media therein,

wherein the three-dimensional shaped object has a surface in a form of a concavity-convexity, and

wherein a part of a contour surface of the flow path for the cooling media and the surface of the concavity-convexity have the same shape as each other.

### EFFECT OF THE INVENTION

According to the present invention (i.e., the method for manufacturing the three-dimensional shaped object and the three-dimensional shaped object), it is possible to obtain the three-dimensional shaped object having the more proper heat removal property as the metal mold. More specifically, when the three-dimensional shaped object is used as the metal mold, it is possible to provide the metal mold having the flow path for the cooling media which is capable of more uniformly performing the removal of the heat arising from the raw material for the molding.

### BRIEF DESCRIPTION OF THE DRAWINGS

FIG. 1 is a cross-sectional view schematically showing a three-dimensional shaped object to be obtained by a manufacturing method according to an embodiment of the present invention.

FIG. 2 is a cross-sectional view schematically showing a three-dimensional shaped object to be used as a metal mold.

FIGS. 3A-3B are cross-sectional views schematically showing a preferable provision position of a flow path for cooling media.

FIG. 4 is a cross-sectional view schematically showing an embodiment regarding a fine configuration.

FIG. 5 is a cross-sectional view schematically showing a formation embodiment of a solidified layer by hybrid systems.

FIGS. 6A-6C are cross-sectional views schematically illustrating a laser-sintering/machining hybrid process for a selective laser sintering method.

FIG. 7 is a perspective view schematically illustrating a construction of a laser-sintering/machining hybrid machine.

FIG. 8 is a flow chart of general operations of a laser-sintering/machining hybrid machine.

### MODES FOR CARRYING OUT THE INVENTION

The present invention will be described in more detail with reference to the accompanying drawings. It should be noted that configurations/forms and dimensional proportions in the drawings are merely for illustrative purposes, and thus not the same as those of the actual parts or elements.

The term “powder layer” as used in this description means a “metal powder layer made of a metal powder” or “resin powder layer made of a resin powder”, for example. The term “predetermined portion of a powder layer” as used herein substantially means a portion of a three-dimensional shaped object to be manufactured. As such, a powder present in such predetermined portion is irradiated with a light beam, and thereby the powder undergoes a sintering or a melting and subsequent solidification to form a shape of a three-dimensional shaped object. Furthermore, the term “solidified layer” substantially means a “sintered layer” in a case where the powder layer is a metal powder layer, whereas term “solidified layer” substantially means a “cured layer” in a case where the powder layer is a resin powder layer. The directions of “upper” and “lower”, which are directly or indirectly used herein, are ones based on a positional relationship between a base plate and a three-dimensional shaped object. The side in which the manufactured three-dimensional shaped object is positined with respect to the base plate is “upper”, and the opposite direction thereto is “lower”. The “vertical direction” described herein substantially means a direction in which the solidified layers are stacked, and corresponds to “upper and lower direction” in drawings. The “horizontal direction” described herein substantially means a direction vertical to the direction in which the solidified layers are stacked, and corresponds to “right to left direction” in drawings.

### Selective Laser Sintering Method

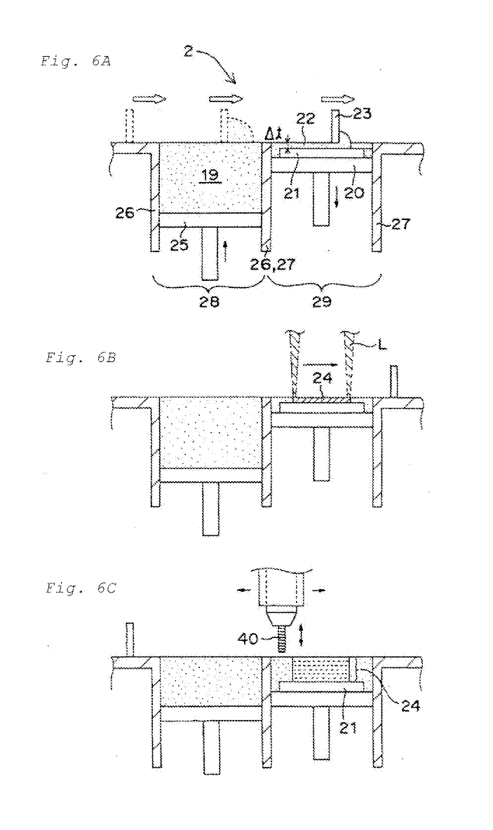

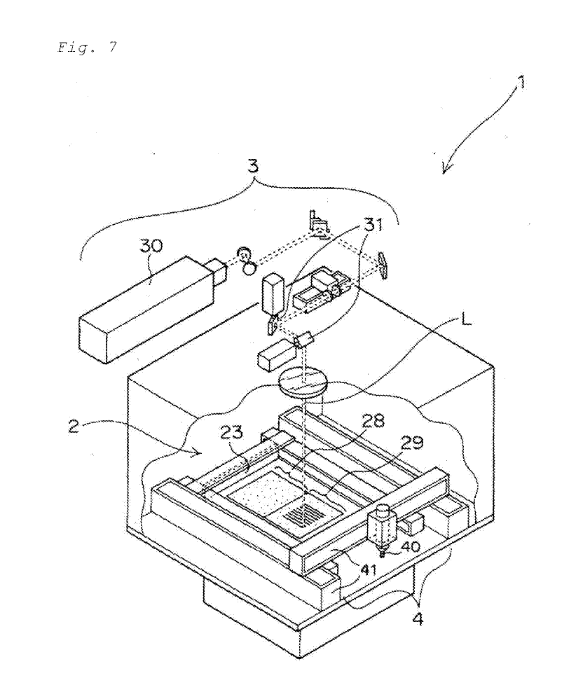

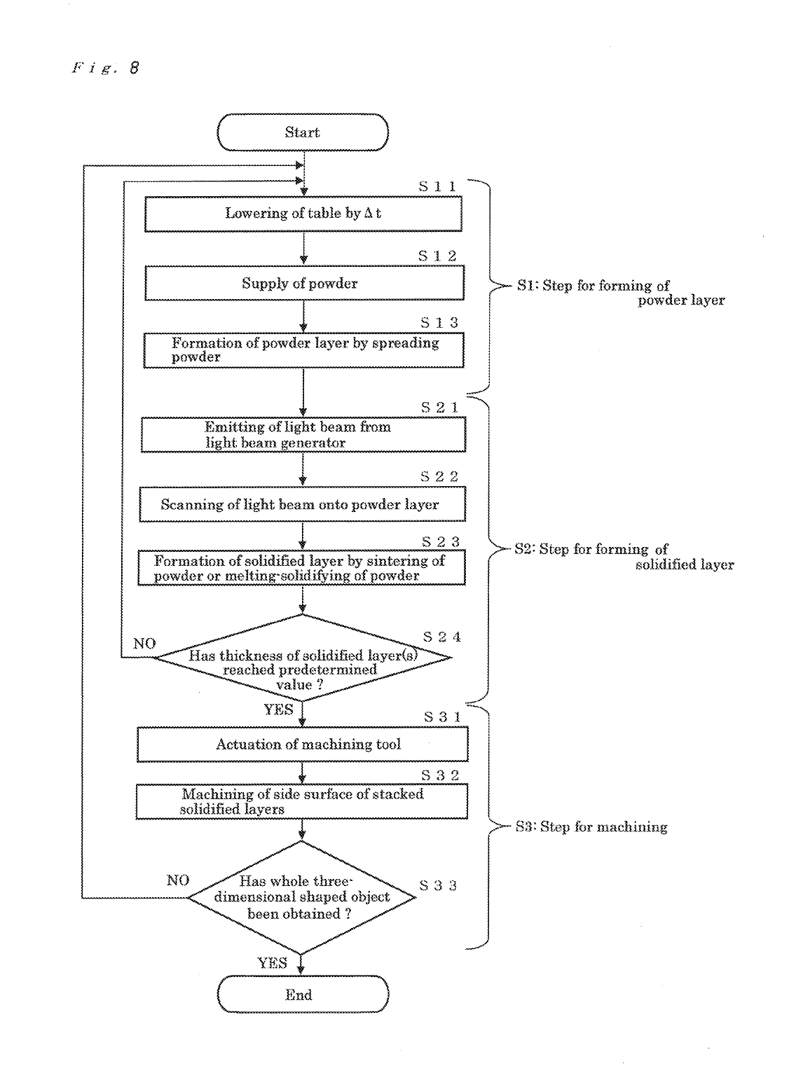

First of all, a selective laser sintering method, on which an embodiment of the manufacturing method of the present invention is based, will be described. By way of example, a laser-sintering/machining hybrid process wherein a machining is additionally carried out in the selective laser sintering method will be especially explained. FIGS. 6A-6C schematically show a process embodiment of the laser-sintering/machining hybrid. FIGS. 7 and 8 respectively show major constructions and operation flow regarding a metal laser sintering hybrid milling machine for enabling an execution of a machining process as well as the selective laser sintering method.

As shown in FIG. 7, the laser-sintering/milling hybrid machine 1 is provided with a powder layer former 2, a light-beam irradiator 3, and a machining means 4.

The powder layer former 2 is a means for forming a powder layer with its predetermined thickness through a supply of powder (e.g., a metal powder or a resin powder). The light-beam irradiator 3 is a means for irradiating a predetermined portion of the powder layer with a light beam “L”. The machining means 4 is a means for milling the side surface of the stacked solidified layers, i.e., the surface of the three-dimensional shaped object.

As shown in FIGS. 6A-6C, the powder layer former 2 is mainly composed of a powder table 25, a squeegee blade 23, a forming table 20 and a base plate 21. The powder table 25 is a table capable of vertically elevating/descending in a “storage tank for powder material” 28 whose outer periphery is surrounded with a wall 26. The squeegee blade 23 is a blade capable of horizontally moving to spread a powder 19 from the powder table 25 onto the forming table 20, and thereby forming a powder layer 22. The forming table 20 is a table capable of vertically elevating/descending in a forming tank 29 whose outer periphery is surrounded with a wall 27. The base plate 21 is a plate for a three-dimensional shaped object. The base plate is disposed on the forming table 20 and serves as a platform of the three-dimensional shaped object.

As shown in FIG. 7, the light-beam irradiator 3 is mainly composed of a light beam generator 30 and a galvanometer mirror 31. The light beam generator 30 is a device for emitting a light beam “L”. The galvanometer mirror 31 is a means for scanning an emitted light beam “L” onto the powder layer, i.e., a scan means of the light beam “L”.

As shown in FIG. 7, the machining means 4 is mainly composed of an end mill 40 and an actuator 41. The end mill 40 is a machining tool for milling the side surface of the stacked solidified layers, i.e., the surface of the three-dimensional shaped object. The actuator 41 is a driving means for allowing the end mill 40 to move toward the position to be machined.

Operations of the laser sintering hybrid milling machine 1 will now be described in detail. As can be seen from the flowchart of FIG. 8, the operations of the laser sintering hybrid milling machine 1 are mainly composed of a powder layer forming step (S1), a solidified layer forming step (S2), and a machining step (S3). The powder layer forming step (S1) is a step for forming the powder layer 22. In the powder layer forming step (S1), first, the forming table 20 is descended by Δt (S11), and thereby creating a level difference Δt between an upper surface of the base plate 21 and an upper-edge plane of the forming tank 29. Subsequently, the powder table 25 is elevated by Δt, and then the squeegee blade 23 is driven to move from the storage tank 28 to the forming tank 29 in the horizontal direction, as shown in FIG. 6A. This enables a powder 19 placed on the powder table 25 to be spread onto the base plate 21 (S12), while forming the powder layer 22 (S13). Examples of the powder for the powder layer include a “metal powder having a mean particle diameter of about 5 μm to 100 μm” and a “resin powder having a mean particle diameter of about 30 μm to 100 μm (e.g., a powder of nylon, polypropylene, ABS or the like”. Following this step, the solidified layer forming step (S2) is performed. The solidified layer forming step (S2) is a step for forming a solidified layer 24 through the light beam irradiation. In the solidified layer forming step (S2), a light beam “L” is emitted from the light beam generator 30 (S21). The emitted light beam “L” is scanned onto a predetermined portion of the powder layer 22 by means of the galvanometer mirror 31 (S22). The scanned light beam can cause the powder in the predetermined portion of the powder layer to be sintered or be melted and subsequently solidified, resulting in a formation of the solidified layer 24 (S23), as shown in FIG. 6B. Examples of the light beam “L” include carbon dioxide gas laser, Nd:YAG laser, fiber laser, ultraviolet light, and the like.

The powder layer forming step (S1) and the solidified layer forming step (S2) are alternately repeated. This allows a plurality of the solidified layers 24 to be integrally stacked with each other, as shown in FIG. 6C.

When the thickness of the stacked solidified layers 24 reaches a predetermined value (S24), the machining step (S3) is initiated. The machining step (S3) is a step for milling the side surface of the stacked solidified layers 24, i.e., the surface of the three-dimensional shaped object. The end mill 40 is actuated in order to initiate an execution of the machining step (S31). For example, in a case where the end mill 40 has an effective milling length of 3 mm, a machining can be performed with a milling depth of 3 mm. Therefore, supposing that “Δt” is 0.05 mm, the end mill 40 is actuated when the formation of the sixty solidified layers 24 is completed. Specifically, the side face of the stacked solidified layers 24 is subjected to the surface machining (S32) through a movement of the end mill 40 driven by the actuator 41. Subsequent to the surface machining step (S3), it is judged whether or not the whole three-dimensional shaped object has been obtained (S33). When the desired three-dimensional shaped object has not yet been obtained, the step returns to the powder layer forming step (S1). Thereafter, the steps S1 through S3 are repeatedly performed again wherein the further stacking of the solidified layers 24 and the further machining process therefor are similarly performed, which eventually leads to a provision of the desired three-dimensional shaped object.

### Manufacturing Method of the Present Invention

An embodiment of the present invention is characterized by a stacking of the solidified layers in the selective laser sintering method.

Specifically, upon the manufacturing of the three-dimensional shaped object in accordance with the selective laser sintering method, the three-dimensional shaped object is manufactured such that it has a flow path for cooling media in the three-dimensional shaped object and also has a surface in a form of a concavity-convexity of the three-dimensional shaped object. Especially, the three-dimensional shaped object is manufactured such that “a part of a contour surface of the flow path for the cooling media to be formed therein” and “the surface of the concavity-convexity thereof” have the same shape as each other. Thus, the manufacturing method of the present invention is characterized in that a shape of the contour surface of the flow path for the cooling media in the three-dimensional shaped object and a shape of the surface of the three-dimensional shaped object have a correlation with each other.

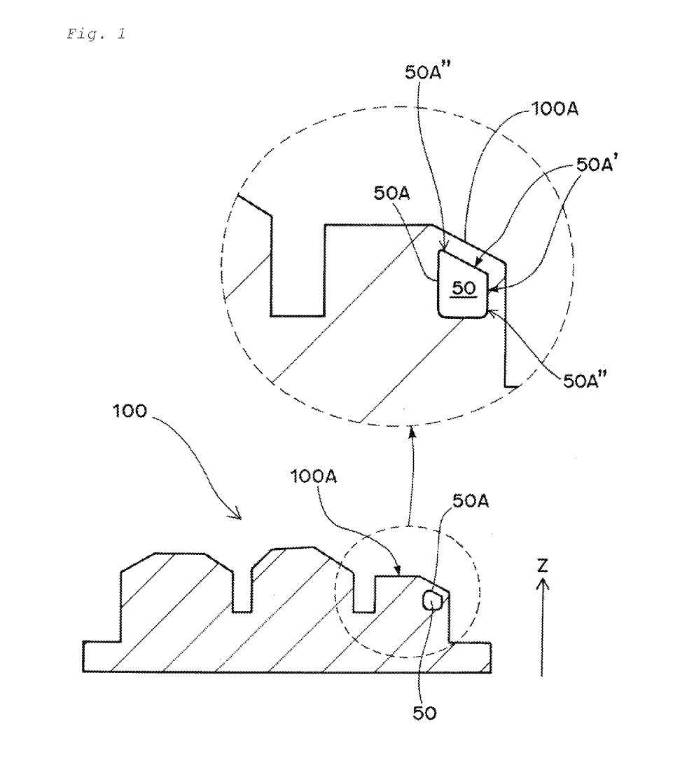

FIG. 1 shows the three-dimensional shaped object to be obtained by the manufacturing method according to an embodiment of the present invention. The three-dimensional shaped object 100 shown in FIG. 1 includes the flow path 50 for the cooling media therein and has the surface 100A in the form of the concavity-convexity. As shown in FIG. 1, a part of the contour surface 50A of the flow path 50 for the cooling media has the same shape as that of the surface 100A in the form of the concavity-convexity. In the manufacturing method according to an embodiment of the present invention, the three-dimensional shaped object 100 is manufactured by performing the stacking of the solidified layers such that the surface 100A of the three-dimensional shaped object 100 and the part of the contour surface 50A of the flow path 50 for the cooling media have a correlated shape with each other.

The phrase “flow path for cooling media” as used herein indicates a passage in which cooling media such as water flow, the cooling media being used for a reduction in temperature of the three-dimensional shaped object. The flow path for the cooling media is used as a passage in which the cooling media flow. Thus, the flow path for the cooling media has a configuration in a form of a hollow portion, and the flow path for the cooling also extends in the three-dimensional shaped object such that it penetrates in the three-dimensional shaped object. It is preferable that the flow path 50 for the cooling media extends in a direction crossing to a solidified direction of the solidified layer (i.e., “z” direction) as shown in FIG. 1.

The phrase “same shape” as used herein means a state that a part of the contour surface 50A of the flow path 50 for the cooling media and the surface 100A of the three-dimensional shaped object 100 have the same shape as each other, in a cross-sectional view of the three-dimensional shaped object 100, the cross-sectional view being obtained by cutting the three-dimensional shaped object 100 along the solidified direction of the solidified layers. The term “same” means substantial same and thus a use of the term “same” is possible even in an embodiment wherein an inevitable or incidental slight offset is provided between shapes to be compared. With respect to “a part of the contour surface 50A of the flow path 50 for the cooling media”, the part of the contour surface 50A does not need to have the same shape as that of whole surface 100A in the form of the concavity-convexity of the three-dimensional shaped object 100. The part of the contour surface 50A may have the same shape as that of at least a part of the surface 100A (See FIG. 1).

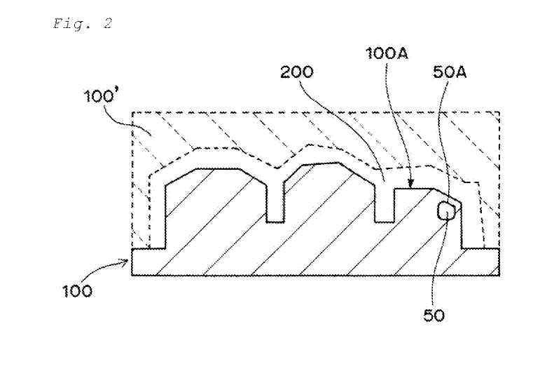

The phrase “formation of the surface in the form of the concavity-convexity” as used herein means an embodiment wherein a formation of the solidified layer is performed such that an outer surface of the three-dimensional shaped object locally has a different hight level. Thus, the phrase “the surface in the form of the concavity-convexity” as used herein means the outer surface of the three-dimensional shaped object locally having the different hight level. When it is assumed that the three-dimensional shaped object 100 is used as a metal mold, the surface 100A in the form of the concavity-convexity corresponds to a so called “cavity forming surface” (FIG. 2). FIG. 2 shows that a mold cavity 200 is provided, the mold cavity 200 being formed by a combination of one three-dimensional shaped object 100 to be used as “core side mold” and another three-dimensional shaped objects 100′ to be used as “cavity side mold”.

In a case when the three-dimensional shaped object 100 to be obtained by the manufacturing method of the present invention is used as the metal mold for the molding, it is possible to more uniformly have an cooling effect by the flow path 50 for the cooling media which is provided in the metal mold. Especially, a more uniform heat transfer from the flow path 50 for the cooling media to the cavity forming surface is possible, the heat transfer specifically being a heat transfer for the cooling. The more uniform cooling effect due to the flow path 50 for the cooling media allows a prevention of an ununiform removal of heat arising from a raw material for a molding, which makes it possible to prevent a shape accuracy of the molded article to be finally obtained from being reduced.

In the manufacturing method according to an embodiment of the present invention, it is preferable that “a part of the contour surface of the flow path for the cooling media” is a “proximal side-contour surface”. Specifically, it is preferable that the proximal side-contour surface 50A′ in the contour surface 50A of the flow path 50 for the cooling media has the same shape as that of the surface 100A in the form of the concavity-convexity as shown in FIG. 1, the proximal side-contour surface 50A′ being positioned proximally to the surface 100A in the form of the concavity-convexity. In a case when the three-dimensional shaped object 100 is used as the metal mold, “the proximal side-contour surface 50A′” corresponds to a contour surface which is positioned more proximally/adjacently to the mold cavity. Thus, “the proximal side-contour surface 50A′” may have a larger effect on the heat transfer to the mold cavity, especially. In light of the above matters, the manufacturing method according to an embodiment of the present invention is characterized in that “the proximal side-contour surface 50A′” has a shape which is correlated to a shape of the surface 100A of the concavity-convexity of the three-dimensional shaped object 100, “the proximal side-contour surface 50A′” having the larger effect on the heat transfer to the mold cavity.

The phrase “proximal side-contour surface” as used herein indicates a contour portion, which is positioned relatively proximally to the surface 100A in the form of the concavity-convexity of the three-dimensional shaped object 100, in the contour surface 50A of the flow path 50 for the cooling media. With reference to the FIG. 1 which is the cross-sectional view of the three-diemensional shaped object, “a contour portion of the flow path for the cooling media” corresponds to the proximal side-contour surface 50A′, “the contour portion” being directly opposed to the surface 100A of the concavity-convexity of the three-dimensional shaped object 100, the cross-sectional view being obtained by cutting the three-dimensional shaped object along the solidified direction of the solidified layers. In manufacturing method according to an embodiment of the present invention, three-dimensional shaped object comprising the flow path for the cooling media is manufactured such that the proximal side-contour surface 50A′ has the same shape as that of the surface 100A of the concavity-convexity. However, an endmost portion 50A″ of the proximal side-contour surface 50A′ may not have the same shape as that of the surface 100A of the concavity-convexity, as shown in the cross-sectional view of FIG. 1.

The proximal side-contour surface 50A′ having the same shape as that of the surface 100A of the concavity-convexity allows more uniform heat transfer from the flow path 50 for the cooling media to the cavity forming surface. Specifically, in a case of the use of the three-dimensional shaped object 100 as the metal mold (See FIG. 2), the heat transfer due to the flow path 50 for the cooling media is easy to be more uniform, and thus the ununiform removal of the heat arising from the raw material for the molding can be effectively prevented. Thus, it is possible to effectively prevent a reduction of the shape accuracy of the molded article to be finally obtained.

In the manufacturing method according to an embodiment of the present invention, a spaced distance is rendered constant, the spaced distance being defined between the proximal side-contour surface 50A′ and the surface 100A in the form of the concavity-convexity (see FIG. 1). Specifically, the flow path 50 for the cooling media is provided such that it has the proximal side-contour surface 50A′ having its contour shape to which a shape of the surface 100A of the three-dimensional shaped object 100 is offset. The phrase “a constant spaced distance” as used herein means a state that a normal line has the same length even in any portion, the normal line being a line connecting “the proximal side-contour surface 50A′ of the flow path 50 for the cooling media” with “the surface 100A of the concavity-convexity of the three-dimensional shaped object 100”, the proximal side-contour surface 50A′ and the surface 100A of the concavity-convexity being opposed/faced to each other. Specifically, the normal line between “the proximal side-contour surface 50A′ of the flow path 50” and “the surface 100A of the three-dimensional shaped object 100” has the same length even in any portion therebetween. The normal line having the same length allows a transfer of a more uniform heat from the flow path 50 for the cooling media to the mold cavity along an extension direction of the proximal side-contour surface 50A′ upon the using of the three-dimensional shaped object 100 as the metal mold. Thus, it is possible to effectively prevent the reduction of the shape accuracy in the molded article to be finally obtained by using the metal mold.

In the manufacturing method according to an embodiment of the present invention, a formation of the flow path for the cooling media is performed in a middle of the stacking of the solidified layers. Specifically, the flow path for the cooling media results from a non-irradiated portion to be obtained by not solidifying a local region in the middle of the stacking of the solidified layers to be provided by the alternate repetition of the powder-layer forming and the solidified-layer forming by the selective laser sintering method. The non-irradiated portion corresponds to a portion not being irradiated with the light beam at “a formation region of the three-dimensional shaped object” which is the predetermined region of the powder layer. Thus, “powders not contributing to a formation of the solidified layer” remain in the non-irradiated portion after an irradiation by using the light beam. The flow path for the cooling media results from a removal of the remaining powders in the three-dimensional shaped object. Especially, in the present invention, the flow path for the cooling media is formed such that a part of the contour surface thereof, i.e., a part of a wall surface for providing a hollow portion which forms the flow path for the cooling media has the same shape as that of the surface of the concavity-convexity of the three-dimensional shaped object to be finally obtained. It is more preferable that a contour portion (i.e., the proximal side-contour surface) which is proximal to the surface of the concavity-convexity of the three-dimensional shaped object has the same shape as that of the surface of the concavity-convexity, the contour portion constituting a part of the flow path for the cooling media.

Subsequent to a completion of the formation of the flow path for the cooling media, the selective laser sintering method is continuously performed. The selective laser sintering method to be used after the formation of the flow path for the cooling media is the same method as that used before the formation of the flow path for the cooling media. The stacking of the solidified layers is re-performed by the alternate repetition of the powder-layer forming and the solidified-layer forming. Finally, the stacking of the solidified layers is performed such that at least a part of the surface of the three-dimensional shaped object has the same shape as that of a part of the contour surface of the flow path for the cooling media, the part of the contour surface especially corresponding to the proximal side-contour surface, the surface of the three-dimensional shaped object especially corresponding to a surface for serving as the cavity forming surface upon the use of the three-dimensional shaped object as the metal mold. Thus, a desired three-dimensional shaped object can be obtained. Specifically, it is possible to obtain the three-dimensional shaped object having the surface in the form of the concavity-convexity and also having the flow path for the cooling media therein, wherein a part of the contour surface of the flow path for the cooling media and the surface of the concavity-convexity have the same shape as each other.

Typical embodiments have been described to promote an understanding of the present invention hereinbefore. The manufacturing method of the present invention can adopt a variety of embodiments.

(Preferable Formation Position of Flow Path for Cooling Media)

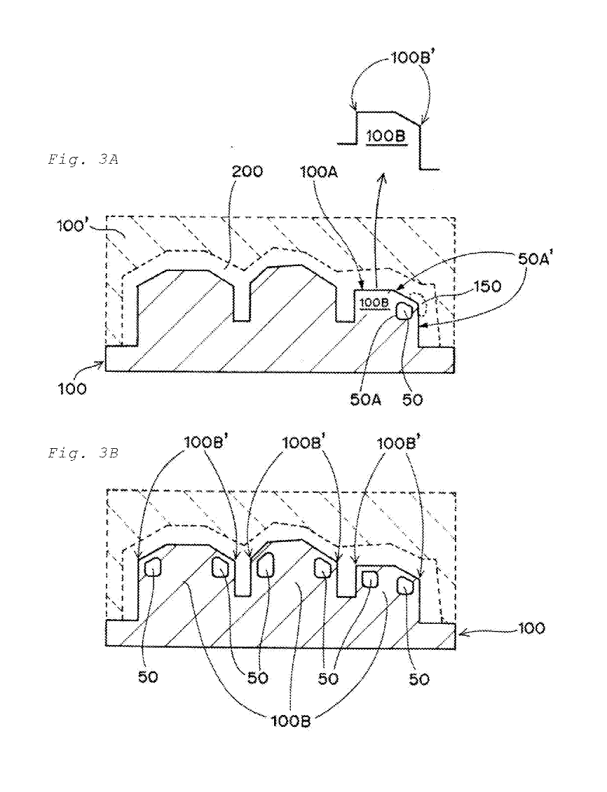

In the manufacturing method according to an embodiment of the present invention, a position of the flow path for the cooling media which is formed in the three-dimensional shaped object may be determined in view of “local heat removal” upon the use of the three-dimensional shaped object as the metal mold. In this regard, it is preferable that the position of the flow path 50 for the cooling media is a corner region of the surface 100A in the form of the concavity-convexity in the manufacturing method according to an embodiment of the present invention (see FIGS. 3A and 3B). As shown in FIG. 3A, it is more preferable that the position of the flow path 50 for the cooling media is an upper surface side-corner region 100B′ of a local portion 100B in a form of a convex, the local portion 100B being formed due to the three-dimensional shaped object 100 having the surface in the form of the concavity-convexity.

In a case when a molding process is performed by using the three-dimensional shaped object 100 as the metal mold, it is more difficult to remove the heat arising from the raw material for the molding positioned at a local portion 150 near the upper side-corner region 100B′ (see FIG. 3A). An existence of the portion which is difficult to perform the heat removal may result in an occurrence of a local warping in a molded article to be finally obtained. In other words, there is a possibility that a partial warping occurs in the molded article, the partial warping beginning from the portion which is difficult to perform the heat removal. Thus, it is more preferable that the flow path 50 for the cooling media is positioned at the upper surface side-corner region 100B′ of the local portion 100B in the form of the convex in order to positively perform a cooling process the portion which is difficult to perform the heat removal. Therefore, the flow path 50 for the cooling media at the upper surface side-corner region 100B′ allows a promotion of the uniform removal of the heat arising from the raw material for the molding positioned at the local portion 150, which leads to an effective reduction of “the local warping” in the molded article to be finally obtained.

The phrase “the local portion in the form of the convex” indicates a bulge portion in the surface 100A of the concavity-convexity of the three-dimensional shaped object 100, especially. When it is assumed that the three-dimensional shaped object 100 is used as the metal mold, a bulge portion in the cavity forming surface which forms the mold cavity corresponds to the local portion 100B in the form of the convex (see FIG. 3A). Furthermore, the phrase “the upper surface side-corner region” means a periphery of a top portion in the local portion 100B in the form of the convex. In view of FIG. 3A, the upper surface side-corner region 100B′ corresponds to a local portion positioned at a relatively peripheral side of a top portion in the form of “convex”, the top portion corresponding to a more upper positioned portion in the local portion 100B in the form of the convex.

In a case where a plurality of the local portions 100B in the form of the convex are provided, i.e., in a case where a plurality of the bulge portions exist in the cavity forming surface which forms the mold cavity, a plurality of the flow paths 50 for the cooling media may be provided in association with the provision embodiment of the plurality of the buldge portions (see FIG. 3B). More specifically, the flow paths 50 for the cooling media may be positioned, respectively at each of “the upper surface side-corner regions 100B′ of the plurality of the local portions 100B in the form of the convex” (see FIG. 3B). A provision of a plurality of the flow paths for the cooling media allows a reduction of the local warping occurring at a plurality portions in a molded article to be finally obtained, which can lead to an effective prevention of the reduction of the shape accuracy of the molded article as a whole.

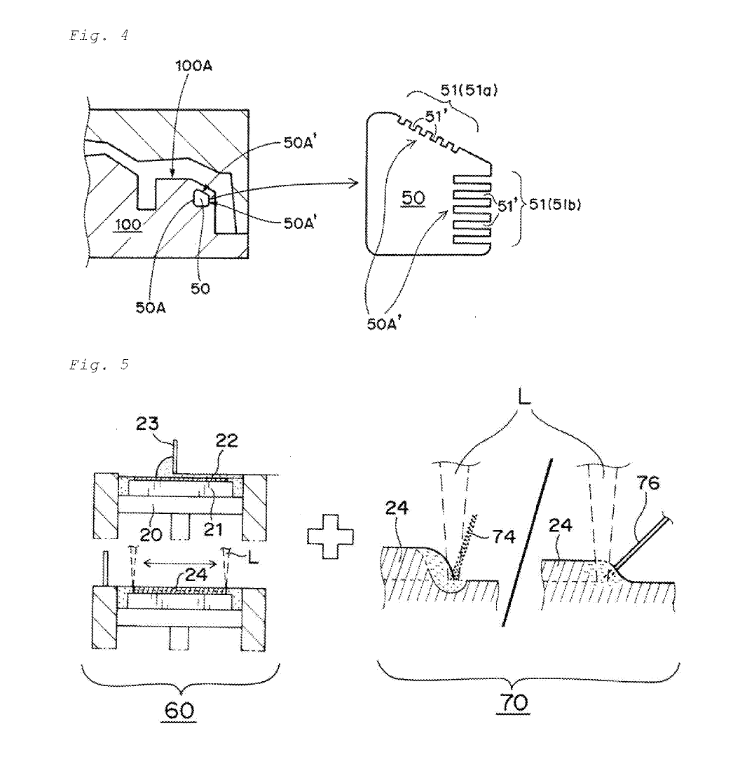

In the manufacturing method according to an embodiment of the present invention, a fine configuration may be formed in the contour surface 50A of the flow path 50 for the cooling media. Specifically, the fine configuration 51 which is composed of a plurality of fine recesssed portions 51′ may be formed in the proximal side-contour surface 50A′ of the flow path 50 for the cooling media (see FIG. 4). A formation of the fine configuration 50 allows the proximal side-contour surface 50A′ having a larger surface area to be formed, and thus a more effective heat transfer from the flow path for the cooling media 50 is possible. In accordance with this embodiment, the proximal side-contour surface 50A′ macroscopically has the same shape as that of the surface 100A in the form of the concavity-convexity, and also the proximal side-contour surface 50A′ microscopically has “the fine configuration 51 which is composed of a plurality of fine recesssed portions 51′” in the proximal side-contour surface 50A′. Thus, it is possible to more uniformly and effectively transfer the heat from the flow path 50 for the cooling media to the cavity forming surface, which can lead to a more effective prevention the reduction of the shape accuracy of the molded article to be finally obtained in a case when the three-dimensional shaped object 100 is used as the metal mold.

The phrase “fine recesssed portion” as used herein means a fine depressed portion extending to a center area of the flow path 50 for the cooling media. A shape of the fine recesssed portion is not limited to a specic shape. Its shape may be any shape if the surface area of the proximal side-contour surface 50A′ can be made larger. A formation of such the fine recesssed portion results from a remaining of the non-irradiated portion upon the formation of the solidified layers, and preferably the fine recesssed portion can be obtained at a point in time when the flow path for the cooling media is formed. More specifically, the fine recessed portion can be obtained by a remaining of a local non-irradiated portion upon the formation of one or more than one solidied layer(s) and a subsequent final removal of powders existing in the local non-irradiated portion, the local non-irradiated portion having a hight level which corresponds to that of the fine recessed portion to be formed.

With respect to the fine configuration 51 composed of such the fine recesssed portions 51′, the proximal side-contour surface 50A′ may comprise a different type of the fine configuration 51. Specifically, at least two types of fine configurations 51 may be formed in the proximal side-contour surface 50A′ (see a partial enlarged view in FIG. 4). The partial enlarged view in FIG. 4 shows that the proximal side-contour surface 50A′ has two types of fine configurations 51 (i.e., a fine configuration 51a and a fine configuration 51b). A surface area of the fine configuration 51a and that of the fine configuration 51b are different from each other. Thus, a heat tranfer process from the flow path 50 for the cooling media having the fine configuration 51a to the surface 100A of the concavity-convexity may differ from that from the flow path 50 for the cooling media having the fine configuration 51b to the surface 100A of the concavity-convexity. An adequate combination of the he fine configurations 51a, 51b shown in the partial enlarged view in FIG. 4 results in a cooling process of the raw material for the molding having a larger degree of freedom by using such the proximal side-contour surface 50A′. Thus, even in case when an easiness of the removal of the heat arising from the raw material for the molding is different due to a difference a shape of the mold cavity, a more adequate cooling of the raw material for the molding is possible in accordance with the difference of the easiness of the heat removal thereof.

The phrase “different type of the fine configuration” substantially means a least one of the fine configuration having the fine recessed portions which have a different configuration, and the fine configuration having a plurality of the fine recessed portions which have a different pitch, the different configuration of the fine recessed portions including a different depth dimension thereof and a different width dimension thereof.

(Provision of Heat Transfer Part)

In the manufacturing method according to an embodiment of the present invention, a heat transfer part may be provided in the three-dimensional shaped object such that the three-dimensional shaped object has the heat transfer part between the proximal side-contour surface of the flow path for the cooling media and the surface of the concavity-convexity of the three-dimensional shaped object.

Especially, it is preferable that the heat transfer part having a high heat conductivity is positioned between the “the proximal side-contour surface” and “the surface of the concavity-convexity of the three-dimensional shaped object”. In this regard, it is preferable that a use of the heat transfer part 18 composed of a material having its heat conductivity higher than that of a material of the three-dimensional shaped object. The use of such the heat transfer part allows the heat transfer from the proximal side-contour surface to the surface of the concavity-convexity to be promoted. Thus, upon the use of the three-dimensional shaped object as the metal mold, it is possible to promote the cooling of the raw material for the molding in the mold cavity. It is preferable that the heat transfer part is composed of a metal material. As the metal material, a use of copper based material which has a higher heat conductivity is preferable. A material comprising beryllium copper can be exemplified as the copper based material.

(Formation of Solidified Layer by Hybrid Systems)

In the manufacturing method according to an embodiment of the present invention, the formation of the solidified layer may be performed in combination with a method other than the selective laser sintering method. Specifically, the formation of the solidified layer may be performed by hybrid systems which combine the selective laser sintering method with a method for the solidified layer other than the selective laser sintering method.

Specifically, as shown in FIG. 5, the formation of the solidified layer 24 may be formed by a hybrid of combined systems of “an after irradiation system 60” and “a simultaneous irradiation system 70”, the after irradiation system 60 being a system that the light beam irradiation is performed after the formation of the powder layer, the simultaneous irradiation system 70 being a system that the light beam irradiation is performed while a raw material is supplied. More specifically, the after irradiation system 60 is a system that the powder layer 22 is irradiated with the light beam L to form the solidified layer 24 after the formation of the powder layer 22. The after irradiation system 60 corresponds to the selective laser sintering method. The simultaneous irradiation system 70 is a system that the supply of the raw material such as a powder 74 or a welding material 76 and the light beam irradiation are substantially simultaneously performed to form the solidified layer 24. The after irradiation system 60 can make a shape accuracy relatively higher, whereas it may make a formation time for the solidified layer relatively longer. In contrast, the simultaneous irradiation system 70 may make a shape accuracy relatively lower, whereas it can make a formation time for the solidified layer relatively shorter. Thus, a proper combination of “the after irradiation system 60” with “the simultaneous irradiation system 70” which have contradictory features respectively can contribute to a more effective manufacturing of the three-dimensional shaped object. More specifically, the hybrid systems complement an advantage and a disadvantage of “the after irradiation system 60” and those of “the simultaneous irradiation system 70” with each other, which makes it possible to manufacture the three-dimensional shaped object having a desired shape accuracy for a shorter time.

Especially, the present invention is characterized by a part of the contour shape of the flow path for the cooling media and the surface of the concavity-convexity of the three-dimensional shaped object, and thus its shape accuracy is required. Thus, a region at which the request of the shape accuracy exists may be formed by “the after irradiation system 60”, and another region at which the request of the shape accuracy does not exist may be formed by “the simultaneous irradiation system 70”. More specifically, with respect to a formation of such as the solidified layer region around the flow path for the cooling media (e.g., the solidified layer region which forms a wall surface of the flow path for the cooling media) and the solidified layer region which forms the surface of the concavity-convexity of the three-dimensional shaped object, “the after irradiation system 60” may be used. Whereas, with respect to a formation of another solidified layer region other than the above regions, “the simultaneous irradiation system 70” may be used.

(Change Embodiment in Cross-Sectional shape of Flow Path for Cooling Media)

In the manufacturing method according to an embodiment of the present invention, the flow path for the cooling media may be formed such that its cross-sectional has a shape which is a homothetic change in an extension direction of the flow path for the cooling media. Specifically, the flow path for the cooling media may be extended such that its cross-sectional has the shape which is the homothetic change in the extension direction of the flow path for the cooling media. In the present invention especially, in a case when the cross-sectional of the flow path for the cooling media has the shape which is a homothetic change along its extension direction, it is preferable that a spaced distance is rendered constant, the spaced distance being defined between a part of the contour surface of the flow path for the cooling media at an optional position and the surface in the form of the concavity-convexity of the three-dimensional shaped object. The part of the contour surface of the flow path for the cooling media at the optional position is preferably the proximal side-contour surface. The phrase “optional position” specifically means an optional position of the flow path for the cooling media along its extension direction. In a case of the use of the three-dimensional shaped object as the metal mold, the constant spaced distance allows a more uniform heat removal-effect by the flow path for the cooling media at the optional position.

(Three-Dimensional Shaped Object of Present Invention)

A three-dimensional shaped object of the present invention is obtained by the above manufacturing method. Thus, the three-dimensional shaped object of the present invention is composed of the stack of the solidified layers to be obtained by irradiating the powder layer with the light beam. As shown in FIG. 1, the three-dimensional shaped object 100 of the present invention is characterized in that it has the flow path 50 for the cooling media therein and also has the surface 100A in the form of the concavity-convexity, wherein a part of the contour surface 50A of the flow path 50 for the cooling media and the surface 100A of the concavity-convexity have the same shape as each other. Thus, the above characteristics allow a more proper heat removal property to be provided. Especially, in a case of a use of the three-dimensional shaped object 100 as a metal mold, a more uniform heat transfer, especially heat transfer for the cooling, from the flow path 50 for the cooling media to a cavity forming surface is possible.

With regard to the three-dimensional shaped object to be used as the metal mold, the three-dimensional shaped object 100 of the present invention can be used as the metal mold for a molding especially. The phrase “molding” means a general molding for obtaining a molded article composed of such a resin, and also means an injection molding, an extrusion molding, a compression molding, a transfer molding or a blow molding for example. The metal mold for the molding shown in FIG. 1 corresponds to a so called “core side” metal mold for the molding, and the three-dimensional shaped object 100 of the present invention may correspond to a “cavity side” metal mold for the molding.

The three-dimensional shaped object 100 according to an embodiment of the present invention to be used as the metal mold has the flow path 50 for the cooling media in which at part of the contour surface 50A thereof has the same shape as that of the surface 100A of the concavity-convexity of the three-dimensional shaped object 100 (see FIG. 1). Especially, in the three-dimensional shaped object 100 according to an embodiment of the present invention, it is preferable that a proximal side-contour surface 50A′ in the contour surface 50A of the flow path 50 for the cooling media has the same shape as that of the surface 100A in the form of the concavity-convexity, the proximal side-contour surface 50A′ being positioned proximally to the surface 100A in the form of the concavity-convexity (see FIG. 1). It is more preferable that a spaced distance is rendered constant, the spaced distance being defined between the proximal side-contour surface 50A′ of the flow path 50 for the cooling media and the surface 100A in the form of the concavity-convexity. More preferably, the flow path 50 for the cooling media has the proximal side-contour surface 50A′, to which a part of the surface 100A of the three-dimensional shaped object 100 is “offset”. For example, the spaced distance, which is defined between the proximal side-contour surface 50A′ of the flow path 50 for the cooling media and the surface 100A in the form of the concavity-convexity of the three-dimensional shaped object 100, is about 0.5 mm-20 mm. When the three-dimensional shaped object 100 having the above features is used as the metal mold for performing a molding process (see FIG. 2), a much more uniform neat transfer from the flow path 50 for the cooling media to the cavity forming surface is possible. Therefore, it is possible to effectively prevent the reduction of the shape accuracy in the molded article to be finally obtained by the metal mold.

A variety of specific features of the three-dimensional shaped object, modified embodiments thereof and technical effects thereon have been described in the above [manufacturing method of present invention]. Thus, these descriptions are omitted in view of an avoidance of overlapping portions.

Although the manufacturing method and the three-dimensional shaped object which is obtained thereby according to an embodiment of the present invention have been hereinbefore described, the present invention is not limited to the above embodiments. It will be readily appreciated by the skilled person that various modifications are possible without departing from the scope of the present invention.

It should be noted that the present invention as described above includes the following aspects:

The first aspect: A method for manufacturing a three-dimensional shaped object by alternate repetition of a powder-layer forming and a solidified-layer forming, the repetition comprising:

(i) forming a solidified layer by irradiating a predetermined portion of a powder layer with a light beam, thereby allowing a sintering of the powder in the predetermined portion or a melting and subsequent solidification of the powder; and

(ii) forming another solidified layer by forming a new powder layer on the formed solidified layer, followed by irradiation of a predetermined portion of the newly formed powder layer with the light beam,

wherein the three-dimensional shaped object is manufactured such that it has a flow path for cooling media in the three-dimensional shaped object, and also has a surface in a form of a concavity-convexity, and

wherein a part of a contour surface of the flow path for the cooling media and the surface of the concavity-convexity have the same shape as each other.

The second aspect: The method according to the first aspect, wherein a proximal side-contour surface in the contour surface of the flow path for the cooling media has the same shape as that of the surface in the form of the concavity-convexity, the proximal side-contour surface being positioned proximally to the surface in the form of the concavity-convexity.
The third aspect: The method according to the second aspect, wherein a spaced distance is rendered constant, the spaced distance being defined between the proximal side-contour surface and the surface in the form of the concavity-convexity.
The fourth aspect: The method according to the second or third aspect, wherein a fine configuration is formed in the proximal side-contour surface, the fine configuration being composed of a plurality of fine recesssed portions.
The fifth aspect: The method according to the fourth aspect, wherein at least two types of fine configurations are formed in the proximal side-contour surface.
The sixth aspect: The method according to any one of the first to fifth aspects, wherein the flow path for the cooling media is positioned at an upper surface side-corner region of a local portion in a form of a convex, the local portion being formed due to the three-dimensional shaped object having the surface in the form of the concavity-convexity.
The seventh aspect: A three-dimensional shaped object comprising a flow path for cooling media therein,

wherein the three-dimensional shaped object has a surface in a form of a concavity-convexity, and

wherein a part of a contour surface of the flow path for the cooling media and the surface of the concavity-convexity have the same shape as each other.

### INDUSTRIAL APPLICABILITY

The manufacturing method according to an embodiment of the present invention can provide various kinds of articles. For example, in a case where the powder layer is a metal powder layer (i.e., inorganic powder layer) and thus the solidified layer corresponds to a sintered layer, the three-dimensional shaped object obtained by an embodiment of the present invention can be used as a metal mold for a plastic injection molding, a press molding, a die casting, a casting or a forging. While on the other hand in a case where the powder layer is a resin powder layer (i.e., organic powder layer) and thus the solidified layer corresponds to a cured layer, the three-dimensional shaped object obtained by an embodiment of the present invention can be used as a resin molded article.

### EXPLANATION OF REFERENCE NUMERALS

22 Powder layer
24 Solidified layer
50 Flow path for cooling media
50A Contour surface of flow path for cooling media
50A′ Proximal side-contour surface
51 Fine configuration
51′ Fine recessed portion
100 Three-dimensional shaped object
100A Surface in form of concavity-convexity of three-dimensional shaped object
100B Local portion in form of convex
100B′ Upper surface side-corner region of local portion in form of convex
L Light beam

1. A method for manufacturing a three-dimensional shaped object by alternate repetition of a powder-layer forming and a solidified-layer forming, the repetition comprising:
(i) forming a solidified layer by irradiating a predetermined portion of a powder layer with a light beam, thereby allowing a sintering of the powder in the predetermined portion or a melting and subsequent solidification of the powder; and
(ii) forming another solidified layer by forming a new powder layer on the formed solidified layer, followed by irradiation of a predetermined portion of the newly formed powder layer with the light beam,
wherein the three-dimensional shaped object is manufactured such that it has a flow path for cooling media in the three-dimensional shaped object, and also has a surface in a form of a concavity-convexity, and
wherein a part of a contour surface of the flow path for the cooling media and the surface of the concavity-convexity have the same shape as each other.

2. The method according to claim 1, wherein a proximal side-contour surface in the contour surface of the flow path for the cooling media has the same shape as that of the surface in the form of the concavity-convexity, the proximal side-contour surface being positioned proximally to the surface in the form of the concavity-convexity.

3. The method according to claim 2, wherein a spaced distance is rendered constant, the spaced distance being defined between the proximal side-contour surface and the surface in the form of the concavity-convexity.

4. The method according to claim 2, wherein a fine configuration is formed in the proximal side-contour surface, the fine configuration being composed of a plurality of fine recesssed portions.

5. The method according to claim 4, wherein at least two types of fine configurations are formed in the proximal side-contour surface.

6. The method according to claim 1, wherein the flow path for the cooling media is positioned at an upper surface side-corner region of a local portion in a form of a convex, the local portion being formed due to the three-dimensional shaped object having the surface in the form of the concavity-convexity.

7. A three-dimensional shaped object comprising a flow path for cooling media therein,
wherein the three-dimensional shaped object has a surface in a form of a concavity-convexity, and
wherein a part of a contour surface of the flow path for the cooling media and the surface of the concavity-convexity have the same shape as each other.
